(19) United States
(12) Patent Application Publication
(10) Pub. No.: US 2024/0273915 A1
(43) Pub. Date: Aug. 15, 2024

(54) REGION-OF-INTEREST DETECTION APPARATUS, REGION-OF-INTEREST DETECTION METHOD, AND ON-TRANSITORY COMPUTER-READABLE STORAGE MEDIUM STORING A COMPUTER PROGRAM

(71) Applicant: Sumitomo Electric Industries, Ltd., Osaka-shi, Osaka (JP)

(72) Inventor: Naoki MAEDA, Osaka-shi, Osaka (JP)

(73) Assignee: Sumitomo Electric Industries, Ltd., Osaka-shi, Osaka (JP)

(21) Appl. No.: 18/561,736

(22) PCT Filed: Feb. 25, 2022
(86) PCT No.: PCT/JP2022/007940

§ 371 Date: Nov. 17, 2023

(30) Foreign Application Priority Data
May 19, 2021 (JP) 2021-084445

(51) Int. Cl. G06V 20/58; G08G 1/16

(52) U.S. Cl. CPC G06V 20/58; G08G 1/166

(57) ABSTRACT

A region-of-interest detection apparatus includes a region-of-interest detection unit configured to detect a region of interest from an image obtained by a camera, mounted on a first movable body, photographing an area in a traveling direction of the first movable body, a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route, and a region-of-interest addition unit configured to perform, based on the meeting point information, addition processing of adding a region including the meeting point in the image to the region of interest.

### TECHNICAL FIELD

The present disclosure relates to a region-of-interest detection apparatus, a region-of-interest detection method, and a computer program. This application claims priority based on Japanese Patent Application No. 2021-084445 filed on May 19, 2021, and the entire contents of the Japanese patent application are incorporated herein by reference.

### BACKGROUND

There has been proposed a system that extracts a characteristic region from an image around a movable body photographed by a camera mounted on the movable body such as an automobile and supports moving of the movable body (refer to, for example, PTL 1).

### PRIOR ART DOCUMENT

### Patent Literature

PTL 1: Japanese Unexamined Patent Application Publication No. 2010-020476

### SUMMARY

A region-of-interest detection apparatus according to an aspect of the present disclosure includes, a region-of-interest detection unit configured to detect a region of interest from an image obtained by a camera, mounted on a first movable body, photographing an area in a traveling direction of the first movable body, a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route, and a region-of-interest addition unit configured to perform, based on the meeting point information, addition processing of adding a region including the meeting point in the image to the region of interest.

A region-of-interest detection method according to another aspect of the present disclosure includes, detecting a region of interest from an image obtained by a camera, mounted on a first movable body, photographing an area in a traveling direction of the first movable body, acquiring meeting point information indicating a meeting point where a second movable body different from the first movable body is capable of meeting the first movable body, the second movable body traveling from a direction intersecting with a traveling route of the first movable body toward the traveling route, and adding, based on the meeting point information, a region including the meeting point in the image to the region of interest.

A computer program according to another aspect of the present disclosure causes a computer to function as a region-of-interest detection unit configured to detect a region of interest from an image obtained by a camera, mounted on a first movable body, photographing an area in a traveling direction of the first movable body, a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route, and a region-of-interest addition unit configured to perform, based on the meeting point information, addition processing of adding a region including the meeting point in the image to the region of interest.

The present disclosure can also be implemented as a computer program for causing a computer to perform the characteristic steps included in the region-of-interest detection method. It is needless to say that such a computer program can be distributed via a computer-readable non-transitory recording medium such as CD-ROM (a compact disc-read only memory) or a communication network such as the Internet. In addition, the present disclosure can be implemented as a semiconductor integrated circuit that implements a part or all of the region-of-interest detection apparatus or may be implemented as a system including the region-of-interest detection apparatus.

### BRIEF DESCRIPTION OF THE DRAWINGS

FIG. 1 is a diagram showing an overall configuration of an object recognition system according to embodiment 1 of the present disclosure.

FIG. 2 is a block diagram showing an example of a configuration of a movable body according to embodiment 1 of the present disclosure.

FIG. 3 is a block diagram showing a functional configuration of a processor according to embodiment 1 of the present disclosure.

FIG. 4 is a diagram showing an example of an image photographed by a camera.

FIG. 5 is a diagram for explaining detection processing of a region of interest by a region-of-interest detection unit.

FIG. 6 is a diagram for explaining detection processing of a region of interest by a region-of-interest detection unit.

FIG. 7 is a diagram showing an example of a meeting point acquired by a meeting point information acquisition unit.

FIG. 8 is a diagram for explaining addition processing of a region of interest by a region-of-interest addition unit.

FIG. 9 is a diagram showing an example of the image of a frame (t+1).

FIG. 10 is a flowchart showing a processing procedure of the control system constituting the movable body.

FIG. 11 is a block diagram showing a functional configuration of a processor according to embodiment 2 of the present disclosure.

FIG. 12 is a block diagram showing a functional configuration of a processor according to embodiment 3 of the present disclosure.

### DETAILED DESCRIPTION

### Problems to be Solved by Present Disclosure

In order to control the movement of a movable body, it is desirable to accurately recognize an object such as another movable body or a pedestrian that affects moving from an image and to process the image without delay.

In order to process an image without delay, it is necessary to extract an image of a region of interest including a predetermined object from the image and to intensively perform recognition processing of the object with respect to the extracted image of the region of interest.

There is a possibility that another movable body, a pedestrian, or the like suddenly appears at an intersection, a doorway of a building on the side of the traveling road of the movable body, a doorway of a parking lot, a crosswalk, or the like.

However, in the conventional system, a region of interest is extracted without considering the possibility of appearance of the movable body. For this reason, the movable body must be moved at low speed in preparation for a case when another movable body enters the intersection from the intersection road without temporarily stopping or a case when the pedestrian suddenly jumps out of the doorway of the building.

The present disclosure has been made in view of such circumstances, and an object thereof is to provide a region-of-interest detection apparatus, a region-of-interest detection method, and a computer program to move a movable body at high speed.

### Advantageous Effects of Present Disclosure

According to the present disclosure, the movable body can be moved at high speed.

### Summary of Embodiments of the Present Disclosure

First, a summary of embodiments of the present disclosure is listed and described. (1) A region-of-interest detection apparatus according to an embodiment of present disclosure includes, a region-of-interest detection unit configured to detect a region of interest from an image obtained by a camera, mounted on a first movable body, photographing an area in a traveling direction of the first movable body, a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route, and a region-of-interest addition unit configured to perform, based on the meeting point information, addition processing of adding a region including the meeting point in the image to the region of interest.

According to this configuration, a region including a meeting point, such as an intersection, a vicinity of a doorway of a building along a road, a doorway of a parking lot, or a crosswalk, where a second movable body such as a vehicle or a person may jump out can be added to the region of interest. Therefore, since the possibility of contact with the second movable body is low in the region outside the region of interest, the first movable body can be moved at high speed.

(2) Further, the meeting point information acquisition unit may be configured to generate the meeting point information by detecting the meeting point from the image.

According to this configuration, meeting point information can be acquired from an image obtained by photographing the area in the traveling direction of the first movable body by the camera mounted on the first movable body, and a region including the meeting point can be added to the region of interest. Therefore, even when meeting point information cannot be acquired from an external apparatus for some reason, such as when the communication function of the first movable body is blocked or when meeting point information is not generated, a region including a meeting point where the second movable body may jump out can be added to the region of interest.

(3) In addition, the meeting point information acquisition unit may be configured to acquire, based on a position of the first movable body, the meeting point information from an external apparatus outside the first movable body.

According to this configuration, even when the meeting point is a blind spot due to the influence of an obstacle or the like in the image photographed by the camera mounted on the first movable body, a region including the meeting point can be added to the region of interest. Therefore, the region of interest including the meeting point can be accurately specified.

(4) In addition, the meeting point information acquisition unit may be configured to generate the meeting point information by detecting the meeting point from an image obtained by photographing the area in the traveling direction of the first movable body, the image being acquired based on a position of the first movable body from an external apparatus outside the first movable body.

According to this configuration, it is possible to detect the meeting point far from the first movable body by acquiring, from the external apparatus, the image obtained by photographing a position that cannot be photographed by the camera mounted on the first movable body, such as an image obtained by photographing a position distant from the first movable body to which the first movable body is scheduled to move.

(5) The region-of-interest detection apparatus may further include, a meeting point information update unit configured to update, based on the image, the meeting point information. The region-of-interest addition unit may be configured to perform, in response to update of the meeting point information, the addition processing.

According to this configuration, even when the image is changed over time, the meeting point information can be updated based on the changed image. Thus, the region including the meeting point as the region of interest can be updated over time.

(6) A region-of-interest detection method according to another embodiment of present disclosure includes, detecting a region of interest from an image obtained by a camera, mounted on a first movable body, photographing an area in a traveling direction of the first movable body, acquiring meeting point information indicating a meeting point where a second movable body different from the first movable body is capable of meeting the first movable body, the second movable body traveling from a direction intersecting with a traveling route of the first movable body toward the traveling route, and adding, based on the meeting point information, a region including the meeting point in the image to the region of interest.

This configuration includes processing characteristic in the region-of-interest detection apparatus described above. Therefore, according to this configuration, the same operation and effect as those of the region-of-interest detection apparatus described above can be achieved.

(7) A computer program according to another embodiment of the present disclosure causes a computer to function as a region-of-interest detection unit configured to detect a region of interest from an image obtained by a camera, mounted on a first movable body, photographing an area in a traveling direction of the first movable body, a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route, and a region-of-interest addition unit configured to perform, based on the meeting point information, addition processing of adding a region including the meeting point in the image to the region of interest.

According to this configuration, the computer can function as the region-of-interest detection apparatus described above. Therefore, the same operation and effect as those of the region-of-interest detection apparatus described above can be achieved.

### Details of Embodiments of Present Disclosure

Embodiments of the present disclosure will be described with reference to the drawings. It should be noted that each of the embodiments described below represents a specific example of the present disclosure. Numerical values, shapes, materials, component elements, arrangement positions and connection forms of component elements, steps, order of steps, and the like shown in the following embodiments are examples, and do not limit the present disclosure. In addition, among the component elements in the following embodiments, component elements not recited in the independent claims are component elements that can be arbitrarily added. Moreover, each drawing is a schematic diagram and is not necessarily strictly illustrated.

The same component elements are denoted by the same reference numerals. Since their functions and names are the same, their descriptions are omitted as appropriate.

### Embodiment 1

### [Overall Configuration of Object Recognition System]

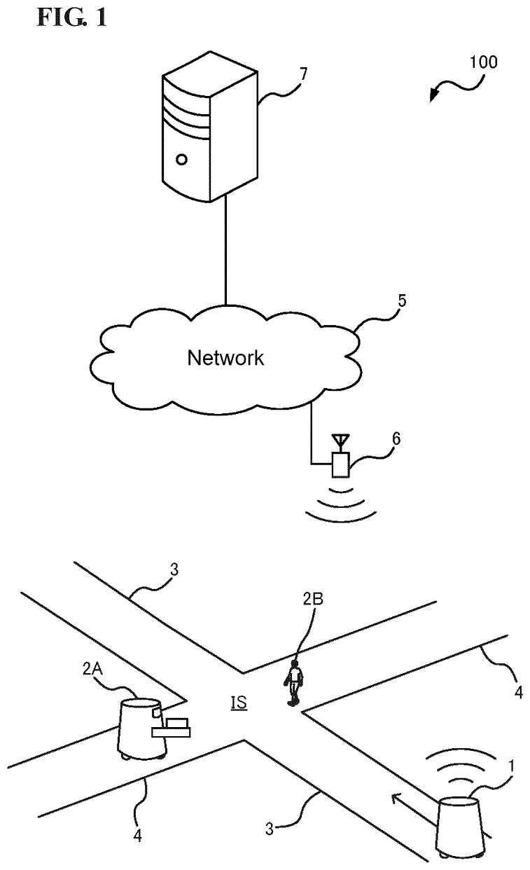

FIG. 1 is a diagram showing an overall configuration of an object recognition system according to embodiment 1 of the present disclosure. Referring to FIG. 1, an object recognition system 100 includes movable bodies 1, 2A, and 2B and a server 7.

Movable body 1 moves on a road 3, for example, and movable body 2A moves on a road 4, for example. Movable body 2B is, for example, a pedestrian moving on road 4. Movable body 1 is capable of wireless communication and is connected to a network 5 via a base station 6. Server 7 is connected to network 5 in a wired or wireless manner.

Base station 6 includes a macrocell base station, a microcell base station, a picocell base station, and the like.

Movable body 1 is, for example, a movable robot such as a conveying robot that conveys a package while autonomously moving in a factory, or a monitoring robot that monitors while autonomously moving in a factory. In the embodiment of the present disclosure, movable body 1 is assumed to be the movable robot. However, movable body 1 is not limited to the movable robot that moves in a factory. Movable body 1 may be, for example, a public vehicle such as a route bus or an emergency vehicle in addition to an ordinary passenger car moving on roads 3 and 4. Movable body 1 may be not only a four wheeled vehicle but also a two wheeled vehicle (motorcycle). Movable body 2A is also, for example, a movable robot. However, like movable body 1, movable body 2A is not limited to the movable robot.

Movable body 1 is provided with a camera as will be described later, and an image obtained by photographing an area in the traveling direction of movable body 1 with the camera. In the embodiment of the present disclosure, it is assumed that the optical axis of the camera faces the front of movable body 1. Therefore, the traveling direction of movable body 1 is taken as the photographing direction of the camera.

Movable body 1 detects, as a region of interest, a region including an object with which movable body 1 may collide from an image photographed by the camera. For example, movable body 1 detects a region including another movable body. In addition, movable body 1 adds, to the region of interest, a region including a meeting point where another movable body is capable of meeting from a direction intersecting road 3 on which movable body 1 moves toward road 3. For example, in an intersection IS, other movable bodies 2A and 2B are capable of meeting from a direction intersecting road 3. Therefore, movable body 1 adds a region including intersection IS to the region of interest.

Movable body 1 cuts out an image of the region of interest from an image photographed by the camera and performs predetermined image processing on the cut-out region-of-interest image to perform predetermined recognition processing. For example, movable body 1 recognizes the type of the object included in the region-of-interest image, and performs moving control including braking control of movable body 1 for reducing the moving speed of movable body 1 when the object is another movable body such as a person or a vehicle, or for safely temporarily stopping movable body 1 when the object is a road sign indicating a temporary stop.

### [Configuration of Movable Body 1]

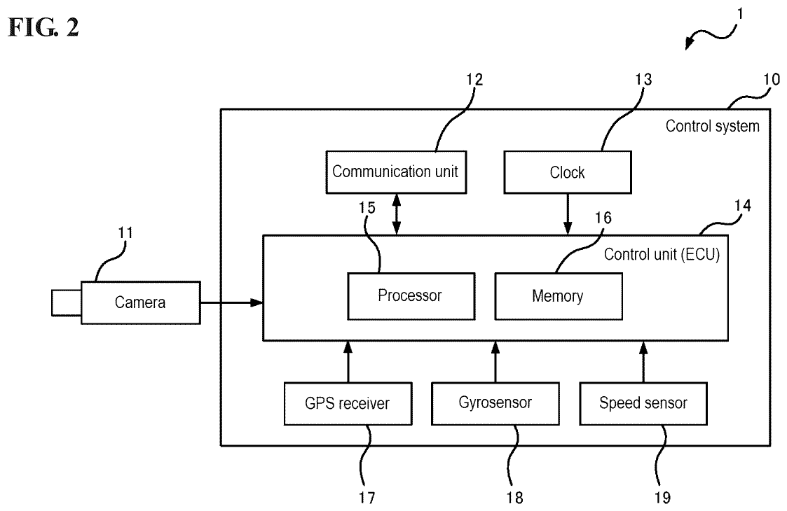

FIG. 2 is a block diagram showing an example of the configuration of movable body 1 according to embodiment 1 of the present disclosure.

As shown in FIG. 2, movable body 1 includes a camera 11 and a control system 10 connected to camera 11. Control system 10 is a system for controlling the movement of movable body 1, and includes a communication unit 12, a clock 13, a control unit (ECU: Electronic Control Unit) 14, a GPS (Global Positioning System) receiver 17, a gyrosensor 18, and a speed sensor 19.

Camera 11 includes an image sensor that captures an image of the surroundings of movable body 1 (specifically, the traveling direction (front) of movable body 1). Camera 11 is a monocular camera. However, camera 11 may be a compound eye camera. The video is composed of a plurality of time-series images.

Communication unit 12 is composed of a wireless communication device capable of performing communication processing corresponding to, for example, 5G (fifth generation mobile communication system). Communication unit 12 may be a wireless communication device already installed in movable body 1, or may be a mobile terminal brought into movable body 1 by a passenger.

The mobile terminal of the passenger is connected to an in-vehicle LAN (Local Area Network) of movable body 1 to temporarily serve as an in-vehicle wireless communication device.

Clock 13 measures the current time.

Control unit 14 includes a computer device that controls devices 11 to 13 and 17 to 19 of movable body 1. Control unit 14 obtains the position of movable body 1 from a GPS signal periodically acquired by GPS receiver 17. Control unit 14 may complement the GPS signal or correct the position of movable body 1 by additionally using a GPS complement signal or a GPS reinforcement signal received by a receiver from a quasi-zenith satellite (not shown).

Control unit 14 complements the position and direction of movable body 1 on the basis of the signals output from gyrosensor 18 and speed sensor 19, and recognizes the accurate current location and direction of movable body 1. Here, the current location of movable body 1 is indicated by, for example, latitude and longitude. The direction of movable body 1 (traveling direction) is indicated by, for example, an angle in a range of 0° to 360° in a clockwise direction with the north as 0°.

GPS receiver 17, gyrosensor 18 and speed sensor 19 are sensors for measuring the current location, direction and speed of movable body 1, respectively.

Control unit 14 includes a processor 15 and a memory 16.

Processor 15 is an arithmetic processing apparatus such as a microcomputer that performs a computer program stored in memory 16.

Memory 16 is configured by a volatile memory element such as a SRAM (Static RAM) or a DRAM (Dynamic RAM), a nonvolatile memory element such as a flash memory or an EEPROM (Electrically Erasable Programmable Read Only Memory), a magnetic storage device such as a HDD (Hard Disk Drive), or an auxiliary storage device using a semiconductor memory such as a SSD (Solid State Drive). Memory 16 stores, a computer program performed by processor 15, data generated when processor 15 performing the computer program, data required when performing the computer program, and the like.

### [Functional Configuration of Processor 15]

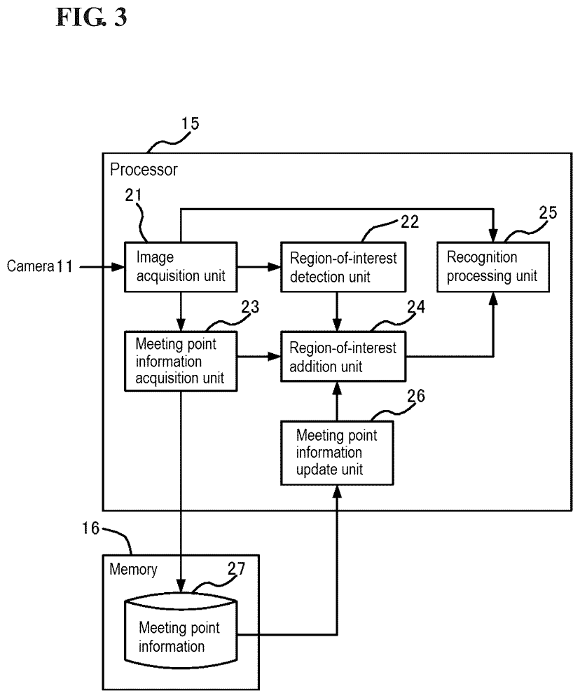

FIG. 3 is a block diagram showing a functional configuration of processor 15 according to embodiment 1 of the present disclosure.

Referring to FIG. 3, processor 15 includes an image acquisition unit 21, a region-of-interest detection unit 22, a meeting point information acquisition unit 23, a region-of-interest addition unit 24, a recognition processing unit 25, and a meeting point information update unit 26 as functional processing units realized by performing a computer program stored in memory 16.

Image acquisition unit 21 sequentially acquires images in front of a movable body 2 photographed by camera 11 in time series. Image acquisition unit 21 sequentially outputs the acquired image to region-of-interest detection unit 22, meeting point information acquisition unit 23, and recognition processing unit 25.

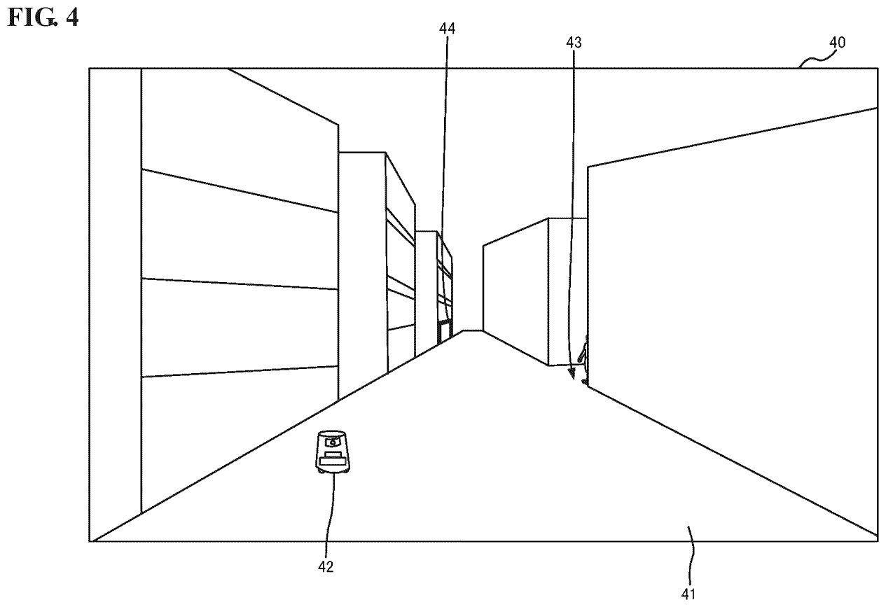

FIG. 4 is a diagram showing an example of an image photographed by camera 11. An image 40 includes a road 41, which is the traveling route of movable body 1, and a movable body 42 moving on road 41. In addition, image 40 includes road 41, an intersection 43 intersecting road 41, and a doorway 44 of a building located beside road 41. Intersection 43 and doorway 44 are examples of meeting points where other movable bodies meet road 41.

Referring again to FIG. 3, region-of-interest detection unit 22 acquires image 40 from image acquisition unit 21 and detects the region of interest from acquired image 40.

The region of interest detected by region-of-interest detection unit 22 is a region including an object that affects the move of movable body 1. For example, the region of interest detected by region-of-interest detection unit 22 includes an object (such as another movable body or an fallen object on a road) with which movable body 1 may collide, and an object (such as a road sign or a traffic light) to be checked by movable body 1 during moving.

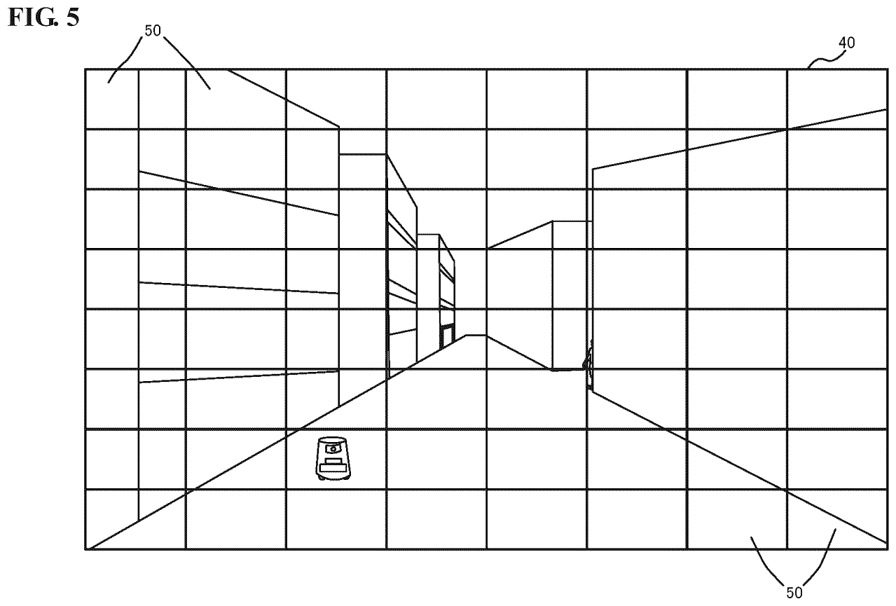

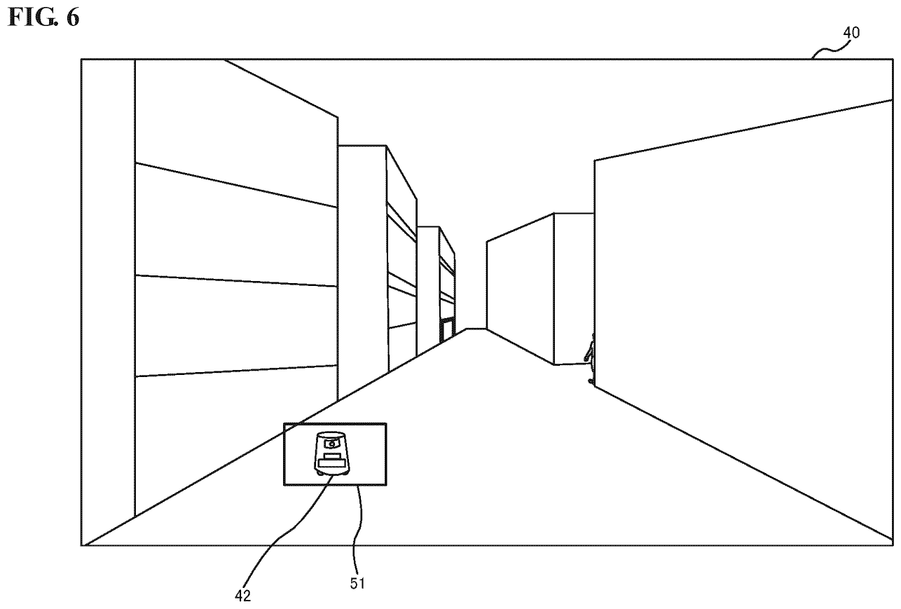

FIGS. 5 and 6 are diagrams for explaining the detection processing of the region of interest by region-of-interest detection unit 22.

Referring to FIG. 5, region-of-interest detection unit 22 divides image 40 acquired from image acquisition unit 21 into a plurality of blocks 50. Here, image 40 is divided into 64 (=8×8) blocks 50. However, the number of divisions of image 40 is not limited to 64.

Region-of-interest detection unit 22 obtains a certainty factor of the region of interest for each block 50 by inputting the image of each block 50 to the learning model. The certainty factor indicates a probability that block 50 includes the region of interest. Note that the image of block 50 may be reduced at a predetermined reduction ratio before being input to the learning model.

The learning model is assumed to have been subjected to machine learning using the image of block 50 including the region of interest as learning data, and outputs the certainty factor indicating the certainty of the region of interest of the image by inputting the image of block 50. The learning model is configured by, for example, a CNN (Convolution Neural Network), an RNN (Recurrent Neural Network), an AutoEncoder, or the like, and each parameter of the learning model is determined by a machine learning method such as deep learning.

In the embodiment of the present disclosure, the region of interest is a rectangle. The region of interest is defined by the upper left corner coordinates of the rectangle and the widths of the rectangle in the X direction and the Y direction. However, the position of the region of interest is not limited to that described above. For example, the region of interest may be defined by upper left corner coordinates and lower right corner coordinates of the rectangle. Alternatively, the region of interest may be defined by an identifier of block 50. In addition, the region of interest may have a shape other than a rectangle, such as an ellipse.

Region-of-interest detection unit 22 detects the region of interest based on the certainty factor obtained from the learning model. For example, region-of-interest detection unit 22 detects block 50 whose certainty factor is equal to or greater than a predetermined threshold as the region of interest.

FIG. 6 shows a region of interest 51 detected by region-of-interest detection unit 22, and block 50 including movable body 42 is detected as region of interest 51.

Referring again to FIG. 3, meeting point information acquisition unit 23 acquires image 40 from image acquisition unit 21 and acquires a meeting point information 27 indicating a meeting point from acquired image 40. Here, the meeting point includes a point where another movable body different from movable body 1 is capable of meeting toward the traveling route from a direction intersecting the traveling route of movable body 1. The meeting point includes, for example, intersection, a doorway of a building located on the side of the traveling route of movable body 1, an exit of a parking lot located on the side of the traveling route of movable body 1, a crosswalk, and the like. From such the meeting point, another movable body such as a conveying robot or a pedestrian may jump out in order to cross the traveling route of movable body 1.

For example, meeting point information acquisition unit 23 acquires the meeting point from the learning model by inputting acquired image 40 to the learning model using the learning model obtained by machine learning with the image including the meeting point as the learning data. In addition, region-of-interest detection unit 22 obtains the certainty factor indicating the certainty of the meeting point from the learning model. The learning model is, for example, a CNN, an RNN, an AutoEncoder, or the like, and each parameter of the learning model is determined by the machine learning method such as deep learning. The meeting point is represented by, for example, coordinates on image 40.

Meeting point information acquisition unit 23 detects the meeting point whose certainty factor is equal to or greater than a predetermined threshold value as the meeting point on image 40.

Meeting point information acquisition unit 23 writes a position of the meeting point and an image around the meeting point (hereinafter, referred to as “surrounding image”) in memory 16 as meeting point information 27. For example, the surrounding image is a rectangle of a predetermined size having the meeting point as a center position. The size of the surrounding image may be fixed or variable. For example, when the learning model outputs the type of the meeting point together with the position of the meeting point, the size of the surrounding image may be determined according to the type of the meeting point.

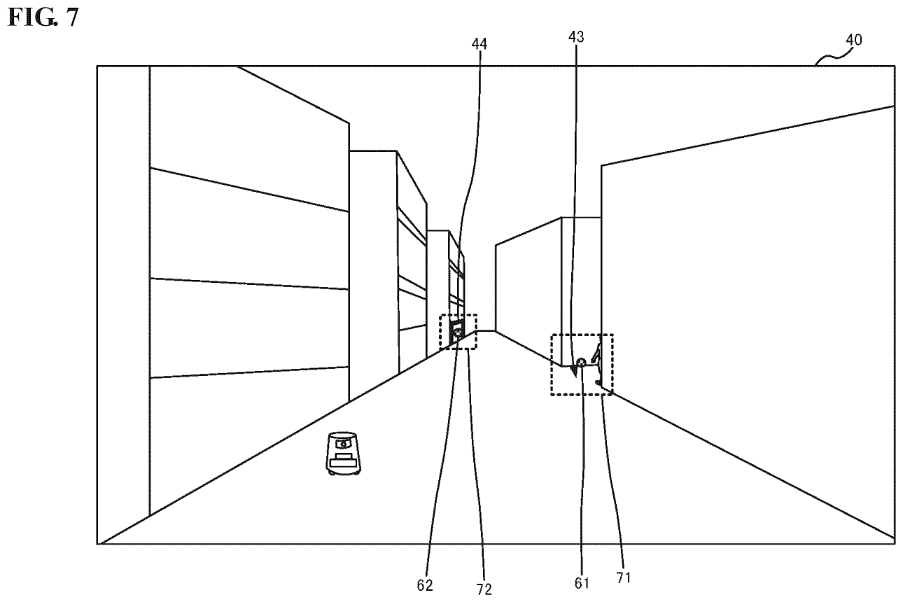

FIG. 7 is a diagram showing an example of the meeting point acquired by meeting point information acquisition unit 23. For example, meeting point information acquisition unit 23 obtains a meeting point 61 and a meeting point 62 by inputting image 40 to the learning model. Meeting point 61 is a position near intersection 43, and meeting point 62 is a position near doorway 44 of the building.

Meeting point information acquisition unit 23 writes the position of meeting point 61 and a surrounding image 71 of meeting point 61, and the position of meeting point 62 and a surrounding image 72 of meeting point 62 into memory 16 as meeting point information 27.

Referring again to FIG. 3, region-of-interest addition unit 24 adds a region including the meeting point acquired by meeting point information acquisition unit 23 to the region of interest detected by region-of-interest detection unit 22 as the region of interest.

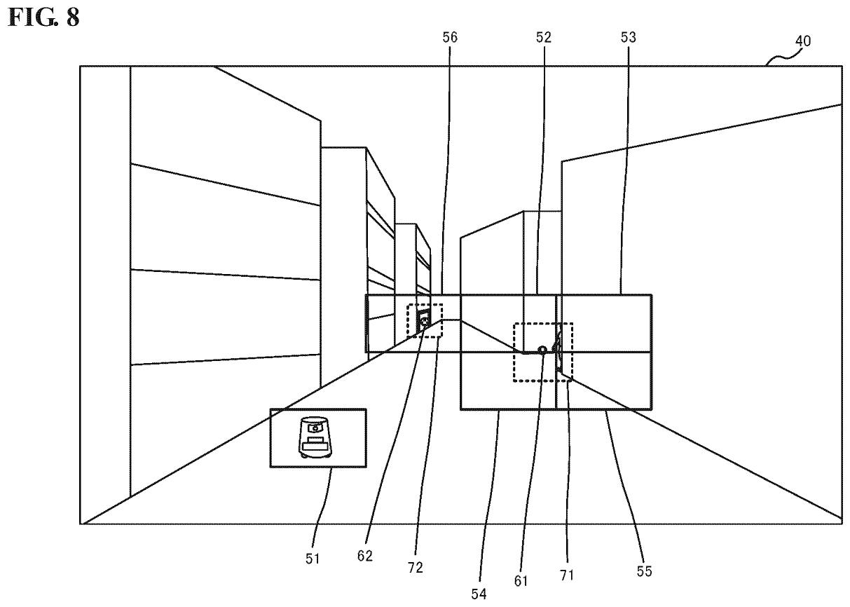

FIG. 8 is a diagram for explaining addition processing of the region of interest by region-of-interest addition unit 24. Region-of-interest addition unit 24 adds regions including the meeting point acquired by meeting point information acquisition unit 23 to region of interest 51 detected by region-of-interest detection unit 22 as regions of interest 52 to 56. For example, region-of-interest addition unit 24 adds a region around meeting point 61 (for example, block 50 including surrounding image 71) as the regions of interest 52 to 55. In addition, region-of-interest addition unit 24 adds a region around meeting point 62 (for example, block 50 including surrounding image 72) as region of interest 56.

Referring again to FIG. 3, meeting point information update unit 26 updates the meeting point by tracking the meeting point acquired by meeting point information acquisition unit 23 among the images acquired by image acquisition unit 21 based on meeting point information 27 stored in memory 16. That is, meeting point information update unit 26 obtains the corresponding position of the meeting point acquired from the image of a frame t at a certain time in the image of frame (t+1) at the next time. Meeting point information update unit 26 sets the corresponding position obtained in the image of frame (t+1) as the meeting point in the image of frame (t+1), thereby tracking the meeting point and updating the meeting point.

Specifically, meeting point information update unit 26 calculates the current location of movable body 1 in frame t and frame (t+1) based on the signals output from GPS receiver 17, gyrosensor 18, and speed sensor 19. Meeting point information update unit 26 estimates a moving distance and a moving direction of the meeting point on the image between frame t and frame (t+1) based on the moving distance and the moving direction of the current location of movable body 1 between frame t and frame (t+1), thereby predicting the meeting point in the image of frame (t+1).

Meeting point information update unit 26 may predict the meeting point on the image of frame (t+1) by predicting the moving direction and the moving distance of the meeting point on the image of frame t based on the speed and the moving direction of movable body 1.

Meeting point information update unit 26 obtains the corresponding position of the meeting point in the image of frame (t+1) by performing matching around the predicted meeting point on the image of frame (t+1) using the surrounding image extracted from the image of frame t as the template image.

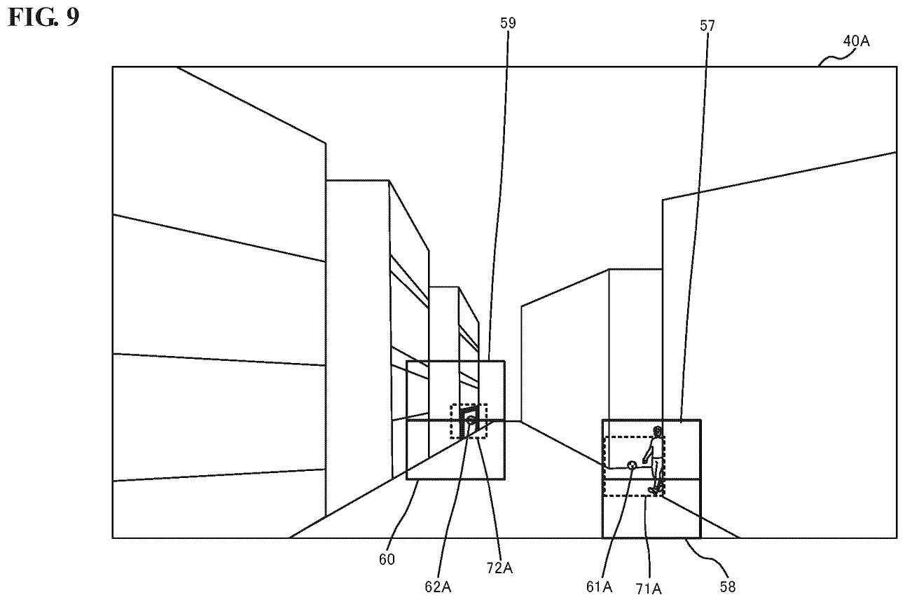

FIG. 9 is a diagram showing an example of an image 40A of frame (t+1). Here, for example, image 40 shown in FIG. 7 is assumed to be image 40 of frame t.

Meeting point information update unit 26 uses each of surrounding image 71 and surrounding image 72 extracted from image 40 as a template image to perform matching around the predicted meeting point of image 40A, thereby obtaining a surrounding image 71A corresponding to surrounding image 71 and a surrounding image 72A corresponding to surrounding image 72. Meeting point information update unit 26 determines a center position of surrounding image 71A as a meeting point 61A corresponding to meeting point 61, and determines a center position of surrounding image 72A as a meeting point 62A corresponding to meeting point 62.

Meeting point information update unit 26 updates the meeting point in the same manner as described above until the next meeting point is acquired by the learning model when the meeting point is not acquired by the learning model for each frame.

Region-of-interest addition unit 24 adds a region including the meeting point updated by meeting point information update unit 26 to the region of interest detected by region-of-interest detection unit 22 as the region of interest.

Referring to FIG. 9, for example, region-of-interest addition unit 24 adds block 50 including surrounding image 71A of updated meeting point 61A as regions of interest 57 and 58. Also, region-of-interest addition unit 24 adds block 50 including surrounding image 72A of updated meeting point 62A as region of interests 59 and 60. The sizes of surrounding image 71A and surrounding image 72A may be the same as those of surrounding image 71 and surrounding image 72, respectively.

Recognition processing unit 25 cuts out the image of the region of interest from the image acquired by image acquisition unit 21 based on the information of the region of interest, detected by region-of-interest detection unit 22, output from region-of-interest addition unit 24 and the information of the region of interest added by region-of-interest addition unit 24.

Recognition processing unit 25 performs predetermined image processing on the cut-out region-of-interest image to perform predetermined recognition processing. For example, recognition processing unit 25 recognizes a display device, a road sign of a temporarily stop, the presence or absence of a pedestrian, and the like from the region-of-interest image. The recognition result of recognition processing unit 25 is used for, for example, automatic moving control of movable body 1.

For example, recognition processing unit 25 obtains the recognition result of the region-of-interest image by inputting the region-of-interest image to the learning model that is machine-learned using the image and the label indicating the recognition result as learning data. The learning model is, for example, a CNN, an RNN, an AutoEncoder, or the like, and each parameter of the learning model is determined by a method such as deep learning. Note that recognition processing unit 25 may perform similar processing on images other than the region-of-interest image.

### [Processing Flow of Control System 10]

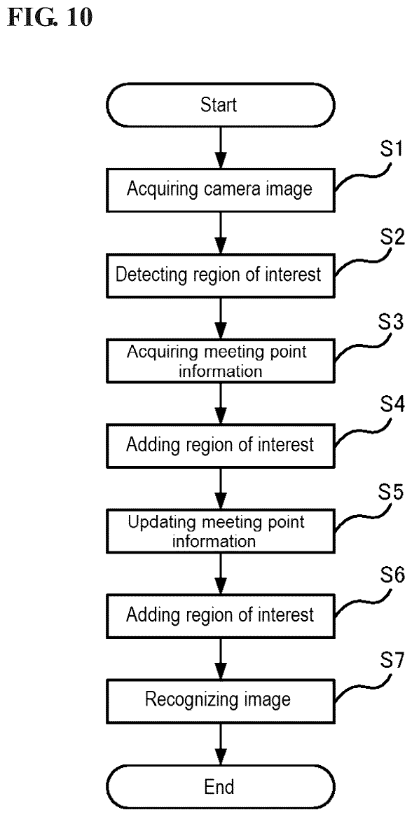

FIG. 10 is a flowchart showing a processing procedure of control system 10 constituting movable body 1.

Referring to FIG. 10, image acquisition unit 21 sequentially acquires images 40 in front of movable body 2 photographed by camera 11 in time series (step S1).

Region-of-interest detection unit 22 acquires image 40 from image acquisition unit 21 and detects a region of interest from acquired image 40 (step S2).

Meeting point information acquisition unit 23 acquires image 40 from image acquisition unit 21, acquires meeting point information 27 indicating the meeting point from acquired image 40 based on the learning model, and writes acquired meeting point information 27 in memory 16 (step S3).

Region-of-interest addition unit 24 adds a region including the meeting point acquired by meeting point information acquisition unit 23 to the region of interest detected by region-of-interest detection unit 22 as the region of interest (step S4).

Meeting point information update unit 26 updates the meeting point by tracking the meeting point acquired by meeting point information acquisition unit 23 among the images acquired by image acquisition unit 21 based on meeting point information 27 stored in memory 16 (step S5).

Region-of-interest addition unit 24 adds a region including the meeting point updated by meeting point information update unit 26 to the region of interest detected by region-of-interest detection unit 22 as the region of interest (step S6).

Recognition processing unit 25 cuts out an image of the region of interest from image 40 acquired by image acquisition unit 21 based on the information of the region of interest detected in step S2 and the information of the region of interest added in step S4 and step S6. Recognition processing unit 25 performs predetermined image processing on the cut-out region-of-interest image to perform predetermined recognition processing. (step S7).

### Effects of First Embodiment

As described above, according to embodiment 1 of the present disclosure, a region including a meeting point, such as an intersection, the vicinity of a doorway of a building along a road, a doorway of a parking lot, or a crosswalk, where another movable body such as a vehicle or a person may jump out can be added to the region of interest. Therefore, since the possibility of contact with another movable body is low in the region outside the region of interest, movable body 1 can be moved at high speed.

Further, meeting point information 27 is acquired from image 40 obtained by photographing an area in the traveling direction of movable body 1 by camera 11 mounted on movable body 1, and a region including the meeting point can be added to the region of interest. Therefore, even when meeting point information 27 cannot be acquired from an external apparatus for some reason, such as when the communication function of movable body 1 is blocked or when meeting point information 27 is not generated, a region including a meeting point where another movable body may jump out can be added to the region of interest.

Further, even when image 40 acquired by image acquisition unit 21 is changed over time, meeting point information update unit 26 can update meeting point information 27 based on changed image 40A. Thus, the region including the meeting point as the region of interest can be updated over time.

### Embodiment 2

In embodiment 1, meeting point information 27 is acquired from image 40. In embodiment 2, an example in which meeting point information 27 is acquired from an external apparatus outside movable body 1 will be described.

The configuration of object recognition system 100 is the same as that of embodiment 1. However, a part of the functional processing unit realized by processor 15 performing the computer program is different from that of embodiment 1.

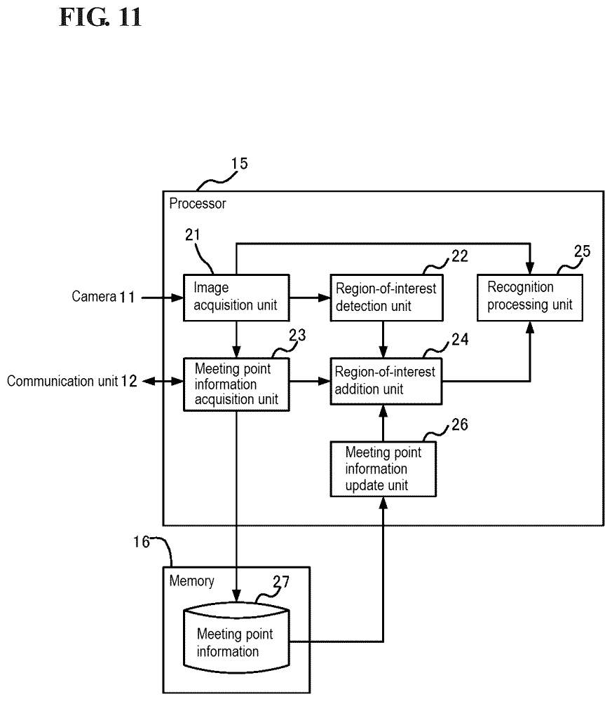

FIG. 11 is a block diagram showing a functional configuration of processor 15 according to embodiment 2 of the present disclosure.

Referring to FIG. 11, processor 15 includes image acquisition unit 21, region-of-interest detection unit 22, meeting point information acquisition unit 23, region-of-interest addition unit 24, recognition processing unit 25, and meeting point information update unit 26 as functional processing units realized by performing the computer program stored in memory 16. The configuration of meeting point information acquisition unit 23 is different from that of embodiment 1.

Meeting point information acquisition unit 23 acquires, based on a position of movable body 1, the meeting point information 27 from the external apparatus outside movable body 1.

For example, meeting point information acquisition unit 23 transmits information of the current location of movable body 1 to server 7 via communication unit 12. Server 7 receives information of the current location of movable body 1 and transmits positional information (positional information in a three dimensional space) of meeting points existing around the current location of movable body 1 to movable body 1. Meeting point information acquisition unit 23 acquires positional information of the meeting point from server 7 via communication unit 12. Meeting point information acquisition unit 23 converts the positional information of the meeting point into positional information on the image acquired by image acquisition unit 21. It is assumed that the correspondence relationship between the position in the three dimensional space and the position on the image is set in advance by performing calibration of camera 11. Meeting point information acquisition unit 23 writes an image around the meeting point on the image as meeting point information 27.

According to embodiment 2 of the present disclosure, even when a meeting point is in a blind spot due to the influence of an obstacle or the like in image 40 photographed by camera 11 mounted on movable body 1, the region including the meeting point can be added to the region of interest. Therefore, the region of interest including the meeting point can be accurately specified.

### Embodiment 3

In the first embodiment, meeting point information 27 is acquired from image 40 photographed by camera 11. In embodiment 3, an example in which meeting point information 27 is acquired based on an image photographed by an external camera other than camera 11 will be described.

The configuration of object recognition system 100 is the same as that of embodiment 1. However, a part of the functional processing unit realized by processor 15 performing the computer program is different from that of embodiment 1.

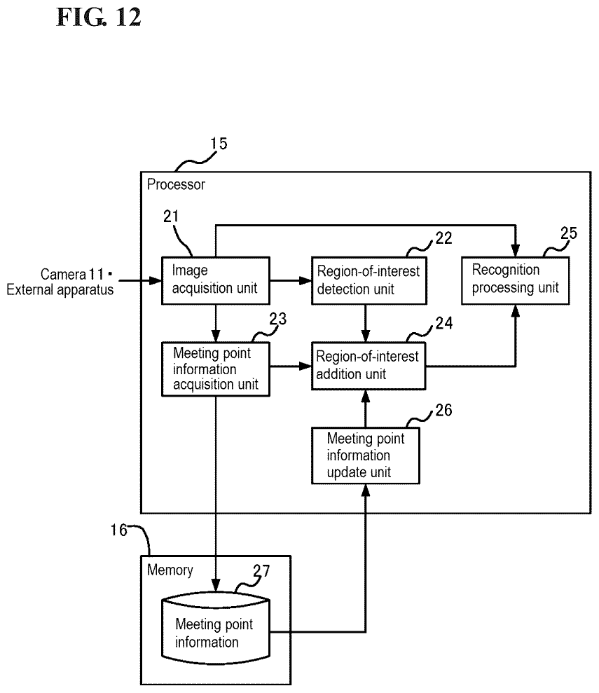

FIG. 12 is a block diagram showing a functional configuration of processor 15 according to embodiment 3 of the present disclosure.

Referring to FIG. 12, processor 15 includes image acquisition unit 21, region-of-interest detection unit 22, meeting point information acquisition unit 23, region-of-interest addition unit 24, recognition processing unit 25, and meeting point information update unit 26 as functional processing units realized by performing the computer program stored in memory 16. The configurations of image acquisition unit 21 and meeting point information acquisition unit 23 are different from those of embodiment 1.

Image acquisition unit 21 transmits positional information of movable body 1 to an external apparatus such as another movable body, a communication apparatus installed on a roadside, or server 7 via communication unit 12. Based on the received positional information, the external apparatus transmits, to movable body 1, an image obtained by photographing the surrounding of the position of movable body 1 photographed by the camera connected to the external apparatus. It is assumed that additional information such as the position of the camera and the photographing range is attached to the image. Image acquisition unit 21 receives the image from the external apparatus.

Meeting point information acquisition unit 23 acquires image 40 photographed by camera 11 or the image acquired from the external apparatus from image acquisition unit 21. Meeting point information acquisition unit 23 acquires positional information of the meeting point from image 40 photographed by camera 11 and the image obtained by photographing an area in the traveling direction of movable body 1 among the images acquired from the external apparatus by the same method as that described in embodiment 1. Meeting point information acquisition unit 23 performs a process of converting the positional information of the meeting point acquired from the image acquired from the external apparatus into the positional information in image 40 photographed by camera 11 based on the attached information of the image. Meeting point information acquisition unit 23 writes the image around the meeting point on image 40 as meeting point information 27.

According to embodiment 3 of the present disclosure, the meeting point far from movable body 1 can be detected by acquiring, from the external apparatus, the image obtained by photographing the position that cannot be photographed by camera 11 mounted on movable body 1, such as the image obtained by photographing the position far from movable body 1 to which movable body 1 is scheduled to move.

### Supplementary Notes

Some or all of the component elements constituting control system 10 may be constituted by one or more semiconductor devices such as system LSIs.

The computer program may be recorded in a non-transitory computer-readable recording medium such as an HDD, an SSD, a CD-ROM, or a semiconductor memory and distributed. In addition, the computer program may be distributed by being transmitted via a network represented by an electric communication channel, a wireless or cable communication channel, and the Internet, or data broadcasting and so on. Control system 10 may be realized by a plurality of computers or a plurality of processors.

A part or all of the functions of control system 10 may be provided by cloud computing. That is, some or all of the functions of control system 10 may be realized by the cloud server. Furthermore, at least a part of the above-described embodiments may be arbitrarily combined.

The embodiments disclosed herein are to be considered as illustrative and not limited in all respects. It is intended that the scope of the present disclosure is not limited to the description above but defined by the scope of the claims, and includes all modifications within the meaning and scope equivalent to the claims.

### REFERENCE SIGNS LIST

1, 2, 2A, 2B, 42 movable body; 3, 4, 41 road; 5 network; 6 base station; 7 server; 10 control system; 11 camera; 12 communication unit; 13 clock; 14 control unit; 15 processor; 16 memory; 17 GPS receiver; 18 gyrosensor; 19 speed sensor; 21 image acquisition unit; 22 region-of-interest detection unit; 23 meeting point information acquisition unit; 24 region-of-interest addition unit; 25 recognition processing unit; 26 meeting point information update unit; 27 meeting point information; 40, 40A image; 43, IS intersection; 44 doorway; 50 block; 51 to 60 region of interest; 61, 61A, 62, 62A meeting point; 71, 71A, 72, 72A surrounding image; 100 object recognition system

1. A region-of-interest detection apparatus comprising:
a region-of-interest detection unit configured to detect a region of interest from a first image obtained by a camera, mounted on a first movable body, photographing an area in a traveling direction of the first movable body;
a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route; and
a region-of-interest addition unit configured to perform, based on the meeting point information, addition processing of adding a region including the meeting point in the first image to the region of interest.

2. The region-of-interest detection apparatus according to claim 1, wherein the meeting point information acquisition unit is configured to generate the meeting point information by detecting the meeting point from the first image.

3. The region-of-interest detection apparatus according to claim 1, wherein the meeting point information acquisition unit is configured to acquire, based on a position of the first movable body, the meeting point information from an external apparatus outside the first movable body.

4. The region-of-interest detection apparatus according to claim 1, wherein the meeting point information acquisition unit is configured to generate the meeting point information by detecting the meeting point from a second image obtained by photographing the area in the traveling direction of the first movable body, the image being acquired based on a position of the first movable body from an external apparatus outside the first movable body.

5. The region-of-interest detection apparatus according to claim 1, further comprising
a meeting point information update unit configured to update, based on the first image, the meeting point information, wherein
the region-of-interest addition unit is configured to perform, in response to update of the meeting point information, the addition processing.

6. A region-of-interest detection method comprising:
detecting a region of interest from an image obtained by a camera, mounted on a first movable body, photographing an area in a traveling direction of the first movable body;
acquiring meeting point information indicating a meeting point where a second movable body different from the first movable body is capable of meeting the first movable body, the second movable body traveling from a direction intersecting with a traveling route of the first movable body toward the traveling route; and
adding, based on the meeting point information, a region including the meeting point in the image to the region of interest.

7. A non-transitory computer-readable storage medium storing a computer program for causing a computer to function as:
a region-of-interest detection unit configured to detect a region of interest from an image obtained by a camera, mounted on a first movable body, photographing an area in a traveling direction of the first movable body;
a meeting point information acquisition unit configured to acquire meeting point information indicating a meeting point where a second movable body different from the first movable body is capable of meeting the first movable body, the second movable body traveling from a direction intersecting with a traveling route of the first movable body toward the traveling route; and
a region-of-interest addition unit configured to perform, based on the meeting point information, addition processing of adding a region including the meeting point in the image to the region of interest.

8. The region-of-interest detection apparatus according to claim 2, further comprising
a meeting point information update unit configured to update, based on the first image, the meeting point information, wherein
the region-of-interest addition unit is configured to perform, in response to update of the meeting point information, the addition processing.

9. The region-of-interest detection apparatus according to claim 3, further comprising
a meeting point information update unit configured to update, based on the first image, the meeting point information, wherein
the region-of-interest addition unit is configured to perform, in response to update of the meeting point information, the addition processing.

10. The region-of-interest detection apparatus according to claim 4, further comprising
a meeting point information update unit configured to update, based on the second image, the meeting point information, wherein
the region-of-interest addition unit is configured to perform, in response to update of the meeting point information, the addition processing.
